(19) United States
(12) Patent Application Publication
(10) Pub. No.: US 2015/0057966 A1
(43) Pub. Date: Feb. 26, 2015

(54) Jump Sensor Device

(71) Applicants: Kirt Alan Winter, San Diego, CA (US); Jose Julio Doval, Escondido, CA (US)

(72) Inventors: Kirt Alan Winter, San Diego, CA (US); Jose Julio Doval, Escondido, CA (US)

(73) Assignee: Xband Technology Corporation, Escondido, CA (US)

(21) Appl. No.: 14/462,496

(22) Filed: Aug. 18, 2014

Related U.S. Application Data
(60) Provisional application No. 61/869,134, filed on Aug. 23, 2013.

(51) Int. Cl. A63B 24/00; G01C 5/00; G01P 15/02

(52) U.S. Cl. CPC A63B 24/0003; G01P 15/02; G01C 5/00; A63B 2220/803
USPC 702/141

(57) ABSTRACT

A jump sensor device and methods of using the device to provide improved measurements of jump height, energy and power measurements of a jump or series of jumps is presented. The device can be used both as an assessment tool and a training aid. Variations are also presented that are applicable to movements in addition to a standing vertical jump.

### CROSS-REFERENCE TO RELATED APPLICATIONS

This application claims priority to U.S. Provisional application 61/869,134, filed on 23 Aug. 2013, titled Jump Sensor Device, by the same inventors and currently pending.

### BACKGROUND OF THE INVENTION

1. Technical Field

The present invention relates to sensors used to capture a sporting or other activity and improved analysis of the sensor data. In particular this application describes a jump sensor.

2. Related Background Art

The use of sensors in sports and other activities to make measurements of the athlete's performance are becoming ubiquitous. Radar guns have long been used to measure the velocity of a pitched baseball; sensors on bicycles now measure speed, power output, pedaling cadence and heart rate of the rider. Video is being used to capture the swing motion of batters, golfers and tennis players. Slow motion replay of a baseball pitcher's motion or a batter's swing has been used for entertainment, instruction and training Sensors and analyses of sensor data are used in a wide variety of sports and activities including for example: baseball, golf, tennis and other racket sports, football, gymnastics, dance and for help in rehabilitation of the people who have lost limbs and are learning how to walk or perform other activities with prosthetics.

Virtually all athletic skill development is an iterative process. One must perform a task, measure the outcome of the task and then analyze one's technique in order to improve. If any of these steps are missing in a training environment, this at best hinders the development of the athlete and at worst, prevents it. Young athletes who strive to compete at the highest levels in their sport are generally very self-motivated. They are the ones who work hardest during practice, stay after practice for extra repetitions and often train alone. Measurement is one of the key feedback mechanisms for specific skill development. In basketball, one can compute their shooting percentage for example while training alone. For many athletes, their vertical jump is used as a measure of training effectiveness and has been found to relate to their performance in a variety of sports. Basketball and volleyball are two obvious sports where a strong vertical jump is required. However sprinters, cyclist and any sport where a burst of leg speed is advantageous can also relate their sports performance to a measure of their vertical jumping ability.

The traditional and still used method for measuring vertical jump is to measure the height the athlete can reach with their extended fingertips in a vertical leap. Typically a mark on the wall is noted or a mechanical height indicator is tripped by their fingertips. The measurement of the height of the vertical jump requires establishing the baseline of the athletes reach when standing on the floor. Errors in this measurement are common as the athlete's body is typically more extended at the apex of the jump than when standing on the ground. Comparison of results from one athlete to another is difficult. Measurements of energy and power can only be based upon a time of flight or height measurement that includes the errors described above. Measurements of the time based impulses and instantaneous power output of a jump are either not possible or based upon assumptions related to the timing of the muscle contractions producing the jump. Movements such as knee jerks and arm swings during the jump are difficult or impossible to account for.

Inaccuracies in measurements of single events are common. Often the inaccuracies result in outlier data that may mislead the coach or athlete and/or result in lost data. Sifting through the data to pick out accurate data from outliers is a difficult and time consuming task. Outlier data may result from actions by the athlete during a single event. Examples include knee jerks or extraordinary arm swings or other body motions during a jump. A means is needed to identify outlier data and remove such data from reporting.

Automatically capturing the time range of interest is an important missing attribute of current systems. Sensors are often gathering data continuously. Yet the event of interest in the performance of the athlete may be just a few seconds or even fractions of a second buried in a mountain of continuous data. If the sensor is an image sensor for example, a coach or the athlete may sort through the image file to edit down to the time of interest. However this editing may not be readily available if the sensor is that of a radar gun or a heart rate monitor or other such device. A means is needed to sort and select the data of interest that is relevant to performance.

Often there is information that if available to a system analyzing sensor data could improve results. For example a video sensor might be able to determine the time of the jump, an accelerometer sensor might provide information regarding the forces of the jump. An acoustic can determine the height of a jump. A means is needed to make use of multiple sensor input to improve measurement results.

Systems are needed that can repeatedly capture instances of a sporting activity including input from a variety of sensors, make measurements of the outcome of each instance of the activity, automatically synchronize the multiple inputs and analyze each instance so that the athlete can compare actions with other athletes as well as their own results of multiple attempts or instances.

### DISCLOSURE OF THE INVENTION

A system is described that addresses the deficiencies described above. A sensor system that makes use of a first sensor that can detect the impulse or movement of the athlete making a jump and a second sensor that can provide an accurate measure of the height of the jump are combined. In a preferred embodiment the first sensor is an accelerometer and the second sensor is an ultrasonic sensor. One embodiment includes an ultrasonic sensor for measuring height, an accelerometer to measure forces, an analysis and control system that uses input from both sensors, a computing device to analyze the results of data acquired during a jump and a display to report the results to the athlete. The data acquired and analysis determines the time of a jump, the height of the jump and the time of the landing as well as force, energy and power measurements. In one embodiment results are reported as the height of the jump and the instantaneous and average power produced. In another embodiment a user interface allows the athlete to input personal specific settings. Such settings include height, weight, and desired analysis and storage of results. In another embodiment the device further includes memory such that current results can be compared with historic results. In another embodiment the jump sensor device further includes means to provide an audio or other prompt for the user to jump. The data or results can be transmitted to a smart phone, tablet, or laptop and displayed on the LCD screen. It can also be sent to the “cloud” via a wired or wireless network connection as well as a cellular connection and be analyzed, and display through a network connection.

In most cases the analysis of a jump can be done in terms of basic physics equations of objects and linear motion. The jump sensor device can provide measurements of the force and location of the user as a function of time. Therefore with the mass of the user one could calculate or measure the force, the acceleration, force equals mass times acceleration (F=m*a), energy and power (energy per unit time). Power can be calculated as the average over the ascent of the jump (from energy=force*distance) the force is the acceleration due to gravity, the measured height is the distance and power is the energy per unit time or the mass of the user times the acceleration due to gravity times the measured height divided by the time from leaving the ground to the apex of the jump (power=m*g*h/Δt). In another embodiment the power is measured as the same energy except over the width of the measured pulse of acceleration as detected by the accelerometer. All of the energy of the jump is generated before the user leaves the ground.

In another embodiment a plurality of ultrasonic sensors are used to triangulate and measure jump height. In one embodiment the plurality of sensors each operate at a different frequency such that interference between sensors is eliminated.

### BRIEF DESCRIPTION OF THE DRAWINGS

FIG. 1 is a diagram showing prior art.

FIG. 2 is a block diagram of the electronic components in an embodiment of the invention.

FIG. 3 is a diagram of a jump sequence.

FIG. 4 is a chart of height versus time for a jump sequence.

FIG. 5 is a diagram of a jump sequence further including a knee jerk.

FIG. 6 is a diagram of height versus time for the jump sequence of FIG. 5.

FIG. 7 includes multiple line graphs of sensor output.

FIG. 8 is a simplified version of the graphs of FIG. 7.

FIG. 9 is a flow chart showing an embodiment of data analysis.

FIG. 10 is an embodiment using multiple sensors in an array around the athlete.

FIG. 11 is an embodiment with a multiple sensors attached to the athlete.

### MODES FOR CARRYING OUT THE INVENTION

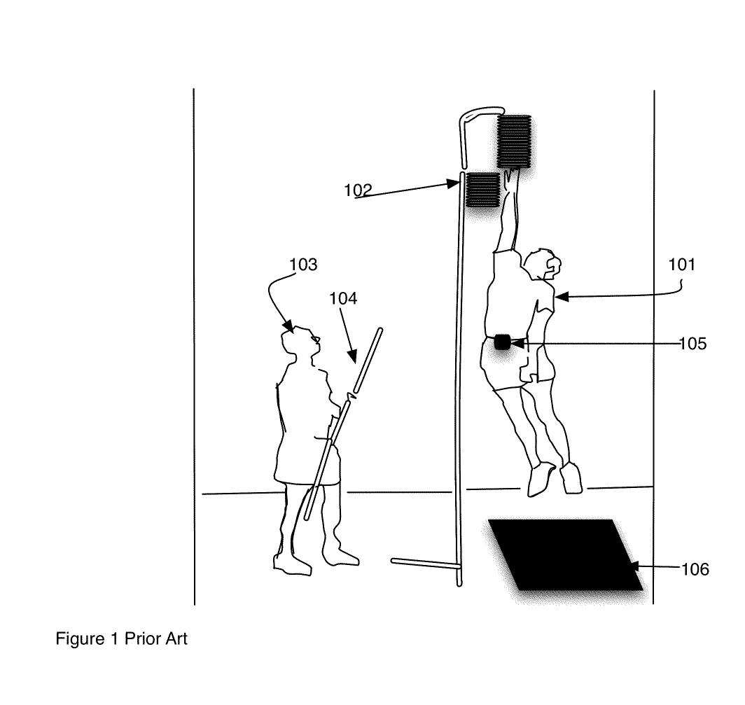

Referring to FIG. 1, examples of prior art are shown. The standard system for measuring jump height includes a jumper/athlete 101 who reaches to flip a set of hinged pegs 102 with his fingertips. The highest peg flipped records the height of the jump. Typically multiple jumps are recorded requiring an assistant 103 who uses a pole 104 to reset the pegs to the original position for a repeat jump. Newer systems include some form of electronics either used in conjunction with the pegs or separately. In some case electronic sensors are included in a mat 106 from which the jumper leaps and on which he lands. Sensors in the mat record the time of both events. In some cases time of flight is used along with classic mechanics to estimate the jump height. In other cases a sensor 105 is attached to the athlete. Sensor known to be used include accelerometers.

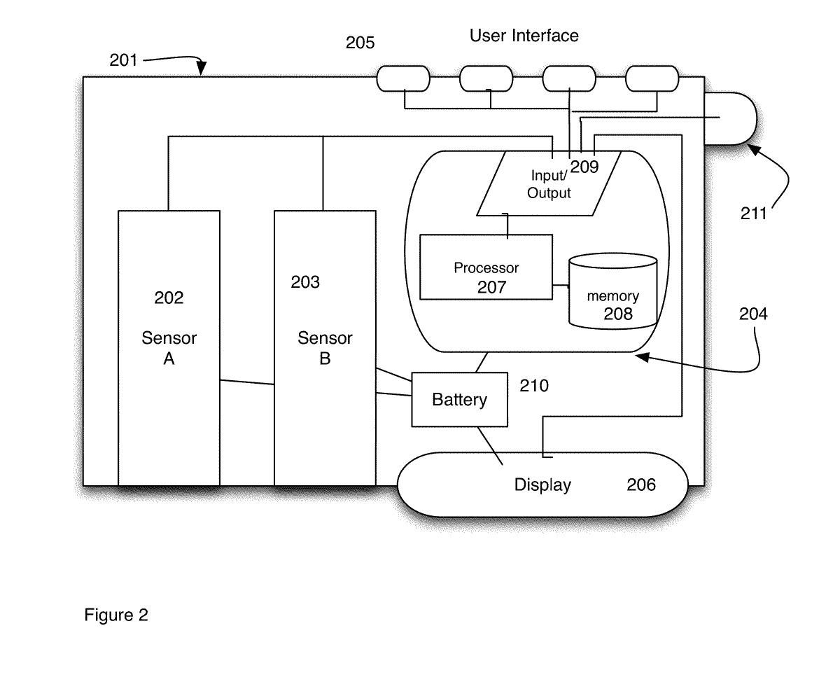

FIG. 2 shows the electronic components included in an embodiment of the present invention. A jump sensor device 201 is comprised of a first sensor 202 and a second sensor 203. In one embodiment the first sensor responds to an impulse movement from the athlete and the second sensor provides a signal that can measure distance. Nonlimiting examples of the first sensor include a strain gauge, a switch and an accelerometer. Nonlimiting examples of the second sensor include an ultrasonic acoustic sensor and an optical sensor. Accompanying the second sensor would be a source signal. An acoustic sensor implies both a source for the acoustic signal as well as an acoustical detector. An optic sensor implies both a light source and an optical detector. Distance can be measured by the second sensor using time of flight and/or interferometry. In a preferred embodiment the first sensor is an accelerometer and the second sensor is an acoustic sensor. The jump sensor device further includes a computing device 204. The computing device includes a processor 207, memory 208 and an input/output port 209. The input/output port is connected to a user interface 205 a port for external communication 211 and a display 206. The jump sensor device 201 further includes a battery 210 to power the sensors and the computing device. Examples of a user interface 205 include a single button, a plurality of buttons, a touch screen and a means for voice input such as a microphone. Nonlimiting examples of the display include a light emitting diode, an array of light emitting diodes to allow display of characters, and a liquid crystal display screen. In one embodiment the user interface touch screen and the display are incorporated into the same device. In another embodiment the user interface further includes a speaker or other audio device that can be used to prompt the user. In another embodiment the user interface includes a visual prompting device such as flashing light emitting diode to prompt the user to jump. Prompts can include an instruction to commence the jump, commence a series of jumps, that a jump has been completed and that a series of jumps has been completed. The external communication port 211 allows connection to a computer or other device for communicating the results of a measurement or to coordinate the measurements of multiple devices. The port 211 may be wired or wireless and may communicate directly with another device or through a local network or through the Internet. In one embodiment the device 201 is part of a mesh network. The processor memory 208 includes instruction to program the processor to activate the sensors and acquire data and process the data into results. In one embodiment the processor further includes programs to communicate the results to other systems through the port 211. In yet another embodiment, the processor is programmed to store the user results in the memory 208 to compare with previous results.

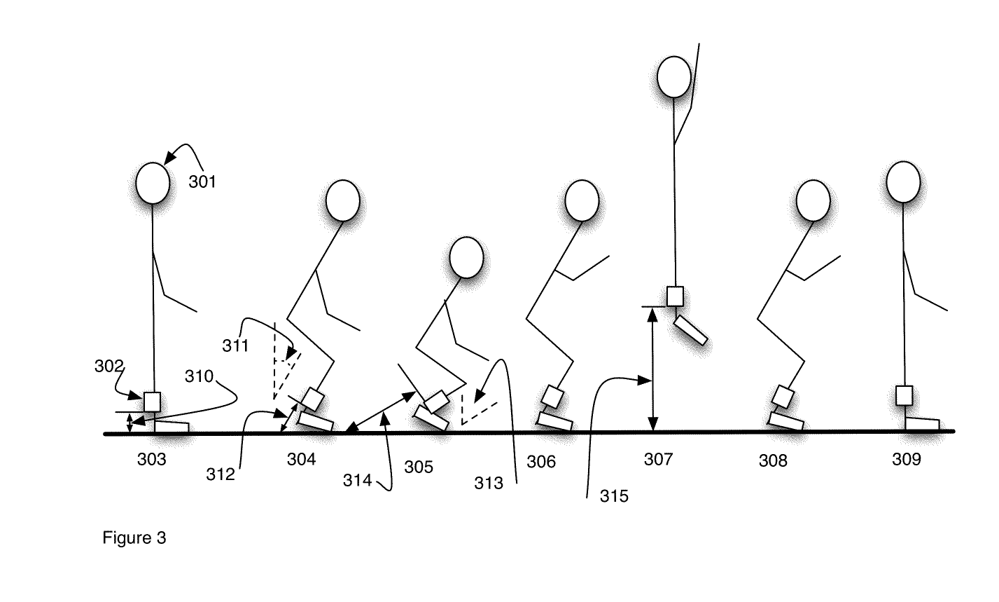

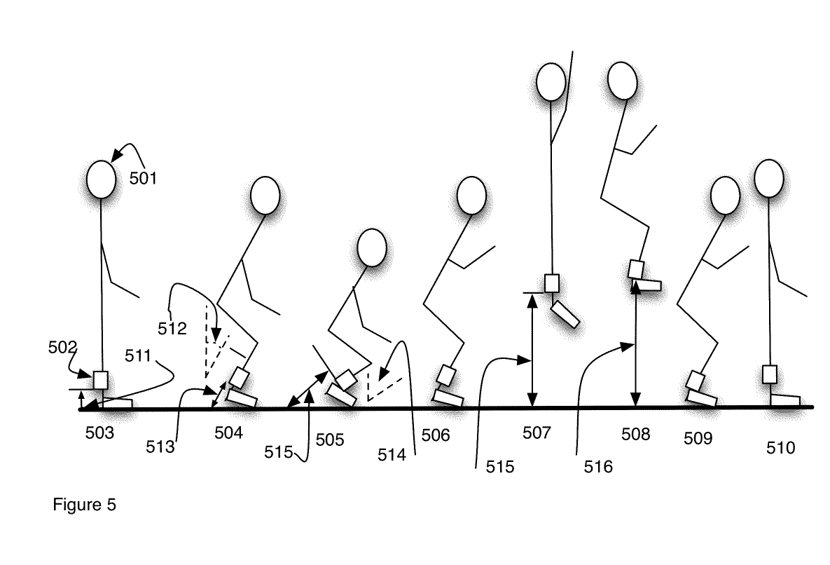

A typical jump sequence is shown in FIG. 3 a user 301 has a jump sensor device 302 attached to their body, shown here as attached to their ankle. The user activates the device and then begins a series of movements 303-309 to accomplish a jump. In this case a standing vertical jump is shown. The jump sensor device includes sensors to measure the distance 310 between the device and the ground. A typical jump includes the user/athlete 301 standing upright 303 followed by entering a crouch 304, 305 and then springing upward 306, 307 into a vertical leap and then landing 308 and returning to the upright position 309. It should be noted that the distance that a line of sight height sensor will detect between the jump sensor device 302 and the ground varies and in fact can increase as the user enters a crouch position prior to a jump. The distance 312, 314 is increased over a baseline distance 310 based upon the angle of the crouch 311, 313. Simple geometry indicates the increased distance is inversely proportional to the cosine of the angle 311, 313 of the crouch. Once the user is airborne 307 the distance 315 is typically not affected by bending the legs unless the user intentionally bends their legs such as in a jump that further includes a knee jerk as shown and discussed in FIG. 5. From the figures it seen that errors are introduced in the determination of the point of departure from the ground based upon a height sensor alone because of the natural movement of the user into a couch. In one embodiment the instant invention minimizes these errors by using both a height sensor and an impulse or movement detecting device to determine the point of departure from the ground. In a preferred embodiment the jump sensor device 302 includes an acoustic sensor to detect the height from the sensor to the ground and an accelerometer to capture the moment of maximum acceleration 306 as the user jumps. Similar errors are introduced upon landing 308 as the user flexes their knees to absorb the shock of landing and similarly one embodiment of the invention uses both a height measurement and an accelerometer to determine the exact time of the landing. In another embodiment the accelerometer provides a force measurement that can be combined with the height measurement to calculate and report the force, energy and power components of the jump. In another embodiment, an electronic gyroscope is used in place of the accelerometer to detect the angular movement while crouching.

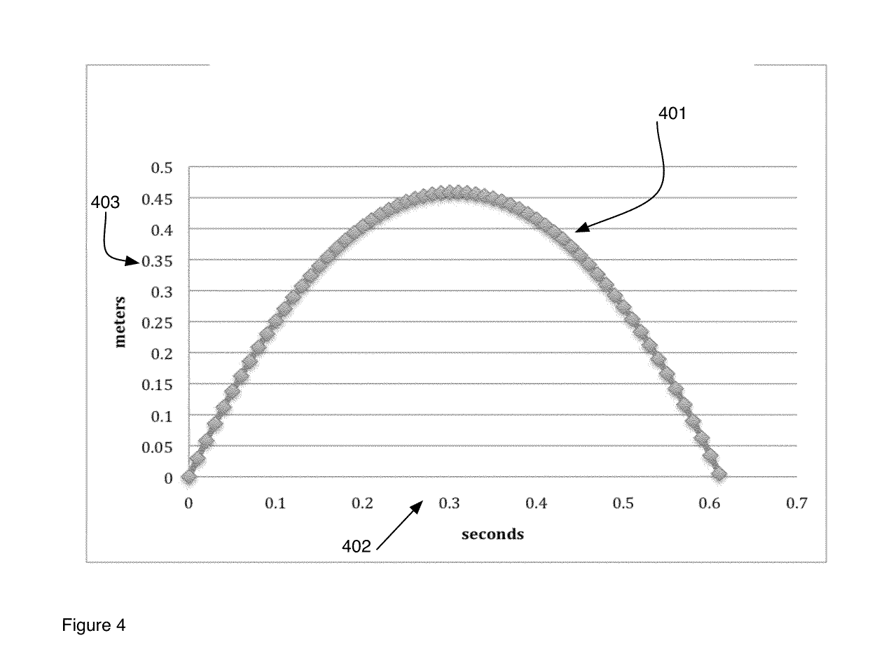

FIG. 4 shows the profile 401 of a theoretical jump. The x-axis is time in seconds and the y-axis 403 is the height of the jump in meters. The jump is for an 80 kg jumper who exerts a force of 1200 newtons over a time period of 0.2 seconds producing an initial velocity of 3 m/s and a jump height of 0.46 meters. The work is force times distance or 80 kg*9.81 m/s²*0.46 m=361 joules. This work was done over the time from 0 to the point of the apex of the jump at 0.31 seconds. The average power for the jump is 361 Joules/0.31 seconds or 1181 watts. The instantaneous power for the impulse of 0.2 seconds is 361/0.2 seconds or 1805 watts. In practice the jump sensor device measures the jump height and the duration of the force applied by the jumper.

FIG. 5 shows the sequence for a jump that further includes a knee jerk. The components of the user's motion are the same as previously discussed in conjunction with FIG. 4 with the addition of a knee jerk near the apex of the jump. The user 501 with a jump sensor device attached to his ankle begins the jump standing upright 503, crouches 504, 505 at angles 512, 514 producing measurements in the distance to the ground 513, 515 that are affected by the angle of the crouch, springs upward 506 and arriving 507 at a height 515. While near the apex of the jump the user in the next image 508 brings their knees upward producing a measurement of jump height 516. The user then lands 509 and becomes upright 510 prior to the next jump.

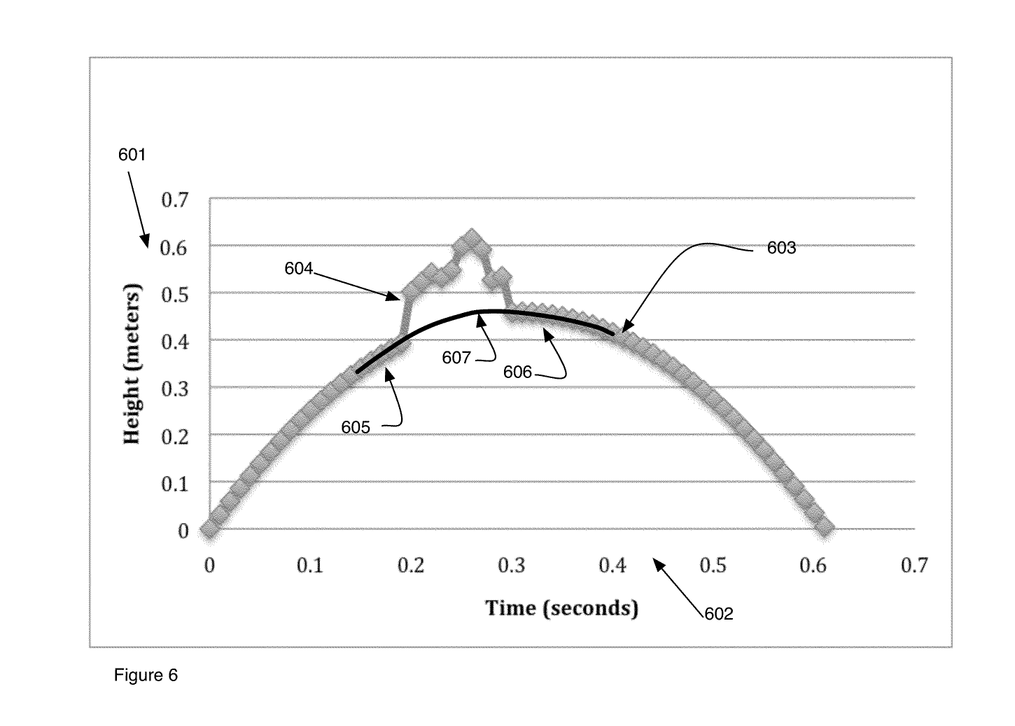

The profile for the jump of FIG. 5 is shown in FIG. 6 As before the y-axis 601 represents height and the x-axis 602 represents time the profile of the jump 603 appears the same as shown in FIG. 4 except the knee jerk adds the bump 604 to the profile. The motion and profile shown represents one exemplary “extraneous” motion that can distort the measurement of jump height and associated energetics. Arm motions or motions of other body parts mid jump can produce similar distortions. In one embodiment the computing device of the jump sensor device is programmed to remove the bump 604 in the calculation of jump height and the associated energy and power factors. In one embodiment the computing device is programmed to fit the observed jump profile to a theoretical curve for uniform linear motion and calculate the height, energy and power based upon the fitted curve. In another embodiment the bump of the curve is replaced by fitting a line 607 to the region before 605 and or after 606 the bump and calculate the jump height based upon the fitted curve. In one embodiment the region of the bump 604 in the data due to an extraneous motion is replaced by the curve that fits the data before and after the bump 604.

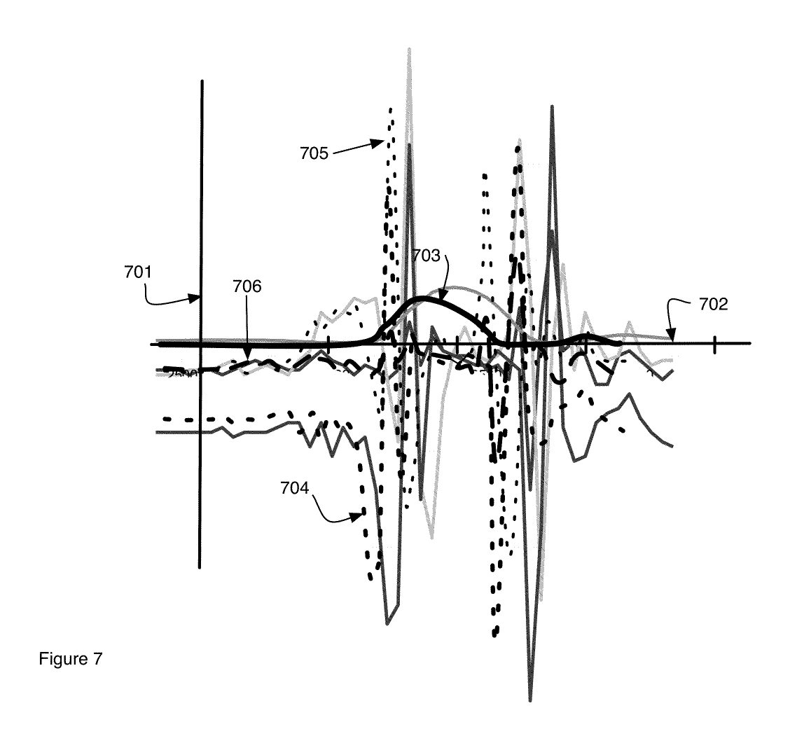

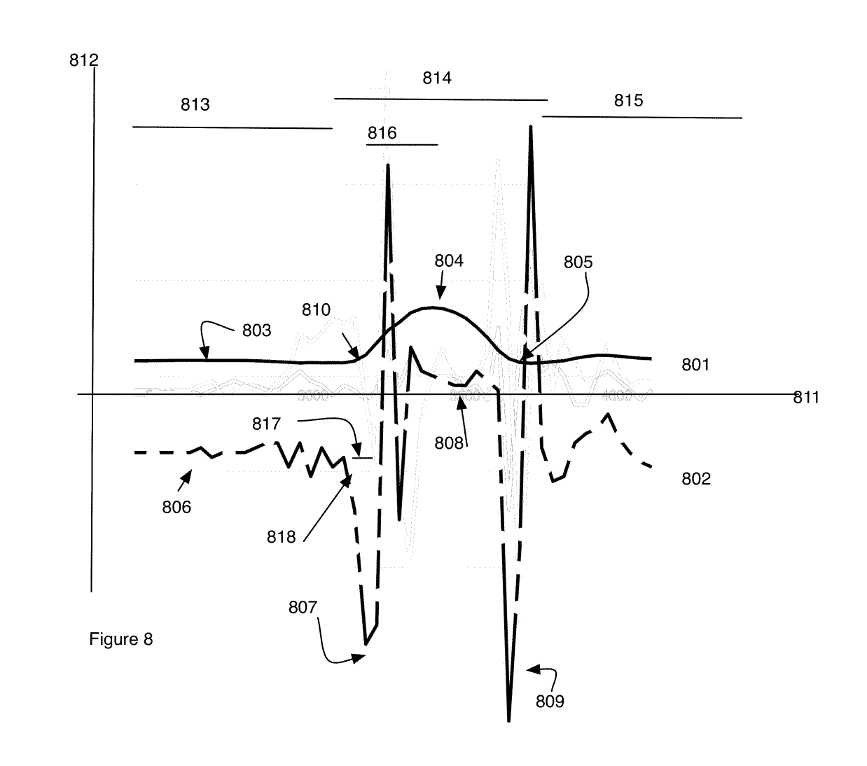

FIG. 7 shows the data from the sensors incorporated in a preferred embodiment. In the preferred embodiment a first sensor is an accelerometer and a second sensor is an ultrasonic device to measure height. The x-axis 702 represents time and the y-axis 701 represents sensor response. For the accelerometer the y-axis represents acceleration and for the ultrasonic device the y-axis represents height of the sensor above a reflecting surface. In general the height is above the ground. In other embodiment other reference surfaces are used. The data shown is for a single jump as characterized in the preceding FIGS. 3 and 4. Four overlapping curves are shown. A first curve 703 represents the data from a height sensor and the other curves 704, 705, 706 are the curves for the acceleration in three orthogonal directions. Although admittedly difficult to fully analyze it is seen that the motion is not completely linear there is acceleration in all three directions as a user jumps. The analysis is more readily seen in FIG. 8 where all but one of the acceleration vectors is removed.

Referring to FIG. 8, the x-axis 811 represents time and the y-axis 812 represents sensor response. The first curve 803 is the data for height measurement sensor and the second curve 806 is for an accelerometer sensor. The data allows splitting the jump into at least 5 distinct regions. The first region 813 is prior to the jump. Both the height curve 803 and the accelerometer curve 806 are flat through this region. Neither movement nor acceleration is taking place. The curves show some movement, especially the accelerometer at the end of this region and at point 818 a large acceleration takes place to point 807 and the user leaves the ground at point 810. In one embodiment the jump sensor device uses the point 807 of the maximum acceleration and the point 810 where height above the ground is first sensed to bound the start of the jump. In another embodiment both the acceleration must peak 807 and height above ground detected 810 to establish the point of leaving the ground. The region 814 represents the jump up and back down. The final region 815 is after landing and there is some residual noise in both sensors until the user settles back into a stance. Power is typically represented in two fashions. Based upon the work done, the mass of the user was moved from the ground to the maximum height 804 over the region 816. The only force acting on the user is gravity and the distance is the height. The energy is force times distance or mass times the acceleration due to gravity (g) times the jump height (h). The power is energy divided by time or m*g*h/length of region 816. However all of the effort of the user takes place in a much smaller region 817 prior to actually leaving the ground. All of the energy input by the user takes place over the region 817 and the instantaneous or peak power generated is m*g*h/length of region 817. Upon landing there is again a large acceleration 809 to counter the falling body of the user and some rebound accelerations as the users settles back to the ground in region 815. In one embodiment the point in time of landing is defined as the point of maximum acceleration 809 and height measured back at the starting height 805.

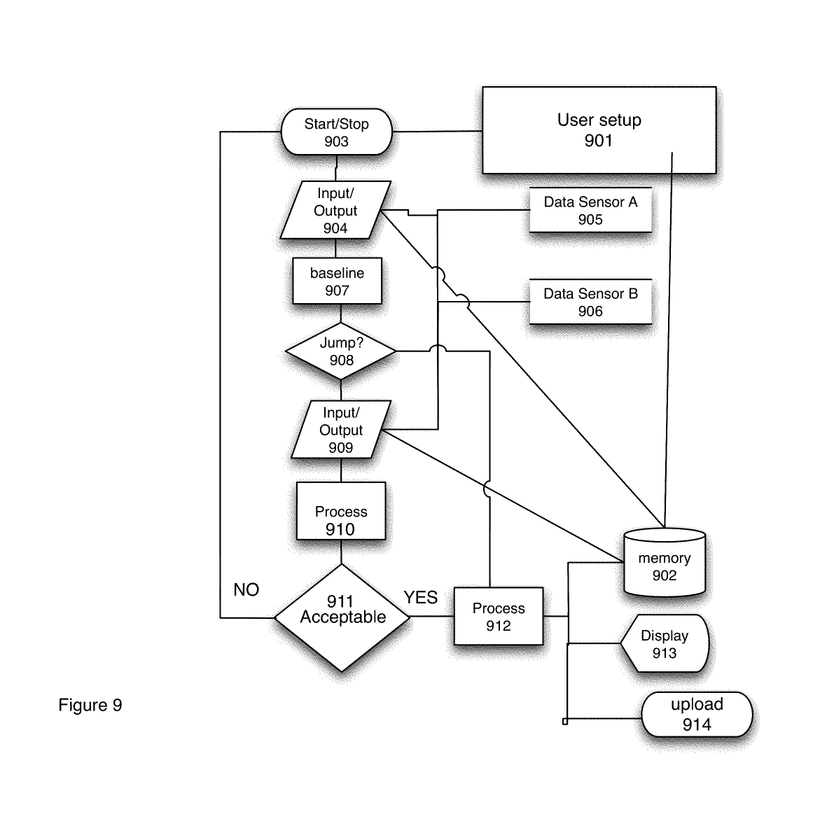

Referring now to FIG. 9, an embodiment for analysis of the jump data is shown. The user may input 901 preferences and initial information in a setup procedure. Setup can include the users weight, the users name, and user preferences for analysis of data, user preferences for storage of data, erasing of previous data and the type of exercise to be initiated. Examples the type of exercise may be a single jump, multiple jumps, timed intervals of jumps and target work or calories to be burnt. The user preferences are stored to memory 902. In one embodiment the user setup includes entering the user name and recalling previously stored user preferences. The user then initiates 903 the selected exercise. Data collection starts 904 and data from the data sensors 905, 906 begins. The data input is processed 907 to set baseline data for the sensors. In one embodiment setting baseline data includes setting a baseline for the data of a first sensor A that measures movement or acceleration while the user is standing still and upright and setting a baseline for height from the data of a second sensor B that measures height of the sensor above the ground or floor on which the user is standing. In one embodiment the jump sensor device prompts the user to jump after the baseline data is set. In another embodiment, where the user has selected a timed routine during user setup 901, the jump sensor device waits for a preselected time interval and then prompts the user to jump. In one embodiment baseline data is set prior to every jump. In another embodiment the baseline data is set only once at the beginning of an exercise session unless it is determined that a reset of the baseline data is required as further described below. Once baseline data is set the process continues acquiring data from the data sensors to detect 908 whether a jump has taken place. In one embodiment a jump is detected on the basis of the arithmetic difference between the measured height and the baseline height being larger than a preselected value. In another embodiment a jump is detected on the basis of the first derivative of the height data versus time being larger than a preselected value. In another embodiment a jump is detected on the basis of the arithmetic difference between the accelerometer data and the accelerometer baseline data being larger than a preselected value. In another embodiment a jump is detected by numerically calculating the first derivative of the accelerometer data versus time and a jump is detected by detecting a peak in the accelerometer data. A peak may be negative or positive excursions from the baseline data. In another embodiment both the height data and the accelerometer data are used to detect a jump. In one embodiment a jump is detected when either the accelerometer or the height measurement indicates a jump by the methods described herein or combinations thereof. In another embodiment a jump is detected when both the height sensor and the accelerometer sensor data indicate a jump has taken place by the methods described herein or combinations thereof. The time of the start of the jump is recorded. Data collection from both sensors continues 909 after the jump is detected. The end of the jump is determined similarly to the methods used to determine the beginning of a jump. The zeroing of the arithmetic difference between the baseline height and the measured height is used to determine that the user has returned to the ground. In another embodiment zeroing of the first derivative of the height versus time is used to determine the user has landed. In another embodiment the accelerometer or other impulse or movement measuring device is used to measure the impact of the user on the ground. In one embodiment the arithmetic difference between the measured data and the baseline data returning to zero is an indication of landing. In another embodiment an excursion or peak in the accelerometer data is used to determine the time of landing. In another embodiment the peak is found by the arithmetically determined first derivative of the accelerometer data versus time. As for the initiation of the jump the time of impact is also determined through use of data from both sensors. In one embodiment either the height or accelerometer data indicating landing is used to select the time of landing or end of the jump (an OR of the sensor data). In another embodiment the time of landing is determined by an indication that both sensors (an AND of the sensor data) indicate landing has taken place. The time of the end of the jump is recorded. Data may be stored to memory 902 for analysis after the jump is completed. Once completed the data is analyzed 910. Data analysis embodiments include determining maximum jump height, jump duration, energy, force and power measurements related to the jump. In one embodiment the analysis takes place in two stages 910, 912 and the second stage 912 is completed only if a test 911 that the data is acceptable is affirmed. In one embodiment data is first analyzed 910 to determine jump height and jump duration. If the jump height or jump duration is within a predetermined reasonable range the data is further analyzed for energy, force, power, etc. In another embodiment a curve is fit to the jump height data over the range after the jump is detected and before landing and arithmetic differences between the fit curve from the theoretical parabolic curve for motion of an object under uniform acceleration (see FIG. 4) are calculated. If the sum of the absolute values of the differences is less than a preselected value, the jump is determined 911 to be acceptable. If the differences are greater than a preselected value the jump is determined 911 to be not acceptable. In one embodiment the difference between the jump data measured values of height and the theoretical curve are compared to a preselected value and if the difference is larger than the preselected value for an individual data point the data point is replaced by data from either the theoretical curve of and average of data points on either side of the data point with a large deviations from the theoretical curve. In another embodiment the measured data points are fit to a curve including first and second order terms in height versus time and the comparison for determining acceptability of the data and potential replacement of individual data points is done on the basis of deviations from the fitted curve by individual data points. In one embodiment if the data is found to be not acceptable the process returns to the starting point 903 and the baseline data are redetermined. In one embodiment (path not shown) the data is analyzed again 911 to determine acceptability using the new baseline data. In another embodiment the data is discarded and the process returns to the start 903.

If found acceptable, the analysis of the data continues 912. Embodiments include analyzing the data for any or all of the values including: maximum force generated, average force generated, work done (energy) in moving from the ground to the maximum height, average power in moving from ground to maximum height, instantaneous power generated over the duration of the acceleration prior to leaving the ground, jump height, jump duration. The maximum force generated is determined from the output of one of the axes of accelerometer data. In another embodiment the maximum force generated is the magnitude of the vector sum of the accelerometer data collected for the three orthogonal directions. In one embodiment the average force generated is determined from accelerometer data by averaging the measured acceleration over the observed time period of the acceleration as defined earlier in conjunction with FIG. 8. In another embodiment the average force is determined from the jump height, the weight of the user/jumper and the time duration of the acceleration: knowing, from classic physics, that the jump height required an initial velocity and the user reached this velocity from a standing zero velocity over the observed time period of the acceleration. The energy expended is the work done in moving a body with the entered mass of the user from the ground to the maximum height against the force of gravity. The average power for the jump is the energy divided by the time from the initiation of the jump to the apex of the jump. The instantaneous power is the energy divided by the time for the acceleration just prior to leaving the ground. The force, energy, power, height and duration of the jump are stored 902 and displayed 913. Other embodiments include methods of using the jump sensor device as a training aid. In another embodiment the user preferences include calculate the total energy expended for a series of jumps. In another embodiment the user preferences include performing a series of jumps and the computing device within the jump sensor device prompts the user to make jumps as preselected intervals. In another embodiment the user preferences include making jumps to expend a preselected amount of energy and the computing device prompts the user to jump until the preselected energy has been expended. In another embodiment the results include determining the time required by the user to expend the preselected amount of energy and a measure of power over the series of jumps is calculated as the total energy expended over the time required to complete the series of jumps by the user. Data results are stored and the user can compare results with historic performance results. In another embodiment the data may be further uploaded 914 to a computer directly connected or through a wireless connection for comparison with past results and other user's results.

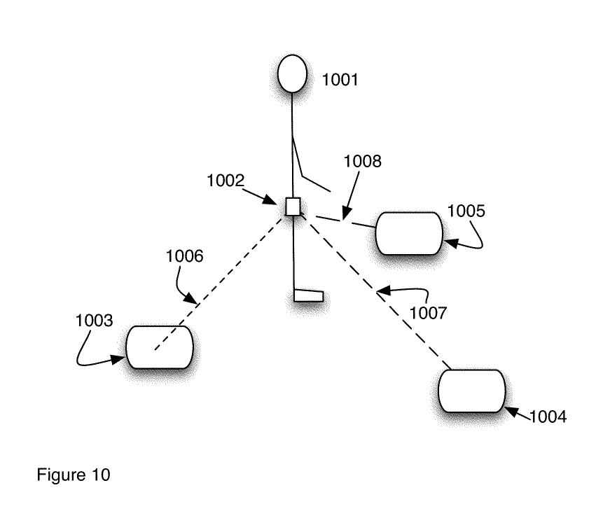

In another embodiment shown in FIG. 10, the jump sensor device includes a plurality of acoustic transducers 1003, 1004, 1005 each in communication with a receiver 1002 that is attached to the user 1001. In one embodiment each of the transducer transmit at a frequency 1006, 1007, 1008 that is unique to the transducer. The height of the jump and in fact the location of the user 1001 can be determined by placing the transducers at known location, calculating the distance between each transducer and the receiver 1002 based upon time of flight of the signal and determining the location of the receiver 1002 by triangulation. In another embodiment the device 1002 attached to the user is an acoustic transmitter and a plurality of receivers 1003, 1004, 1005 are placed at known locations around the user. Again the location of the user can be determined in three dimensions by triangulation. In another embodiment the device 1002 attached to the user further includes an accelerometer. In this fashion both acceleration and location data is provided and can be analyzed in much the same way as already discussed. Such a setup is more conducive to analysis of both vertical jumps as well as running jumps and gymnastic movements.

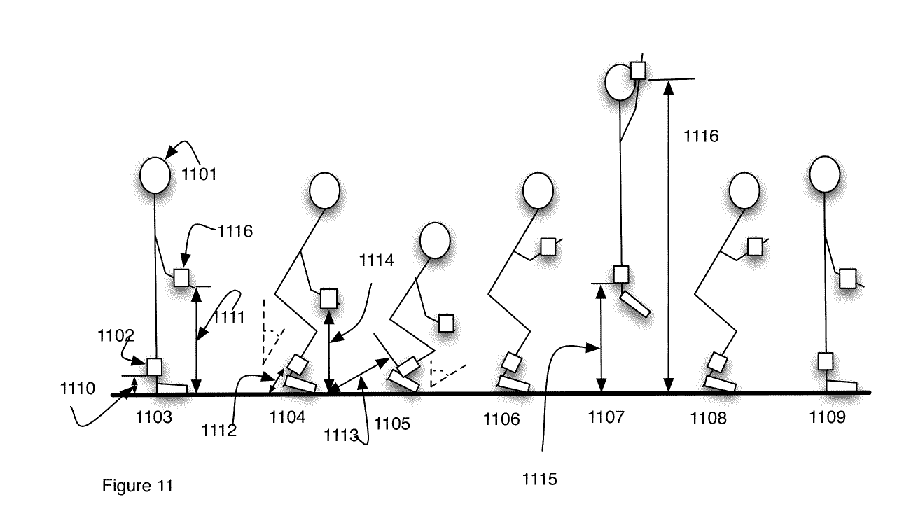

In another embodiment shown in FIG. 11 a plurality (two shown here) jump sensor devices 1102, 1116 are attached to a user 1101. The user proceeds through the same sequence of actions representing a vertical jump as already discussed however in this case height and acceleration data is obtained from a pair of sensors rather than a single sensor as described in FIGS. 1-9. Baseline height measurements 1110, 1111 are determined for each of the sensors. The sensors will display different angular effects on the height 1112, 1113, 1114 as the user begins the sequence of a jump. In one embodiment the multiple sensors can communicate with one another such that results of multiple sensors are used to determine the beginning and end of a jump sequence. In another embodiment the multiple sensors communicate with a central processor either located on the user or remote from the user. Communication can be through wired or wireless means. The height of the jump at its apex further includes the distance 1115 from the user to the ground as well as the distance 1116 from the users outstretched arm to the ground. Such a setup allows comparison with prior art mechanical systems for measuring jump height discussed in conjunction with FIG. 1. Each of the sensors may further include accelerometers to proved additional data related to the jump and to aid in the calculations of the power and energy factors related to each jump or sequence of jumps. Other embodiments include additional sensors located at other points on the user's body.

### SUMMARY

A jump sensor device and methods of using the device to provide improved measurements of jump height, energy and power measurements of a jump or series of jumps is presented. The device can be used both as an assessment tool and a training aid. Variations are also presented that are applicable to movements in addition to a standing vertical jump.

Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

What is claimed is:

1. A jump sensor device comprising:
a) a first sensor that can detect a movement said sensor one of an accelerometer, a switch and a strain gauge,
b) a second sensor that can detect a distance said second sensor one of an acoustical source and acoustical detector, and, an optical source and optical detector,
c) a computing device that is programmed to: accept user preferences, acquire data points from the sensors at multiple points in time during a jump sequence by a user, to calculate measurements related to the jump, and, to report the measurements, where the measurements include at least one of: the height of the jump, the duration of the jump, the force expended, the energy expended during the jump, the average power for the jump and the instantaneous power for the jump,
d) where the computing device is programmed to use the data from both of the sensors to determine the time at the start of the jump, the height of the jump and the time of the end of the jump.

2. The jump sensor device of claim 1 wherein the first sensor is an accelerometer and the second sensor is an acoustical source and an acoustical sensor.

3. The jump sensor device of claim 1 wherein the computing device is further programmed to mathematically fit the height data points as a function of time from the second sensor to a parabolic curve and based upon the calculated difference between the parabolic fit curve and the measured data points determine if the data points measured by the sensors are within pre-selected bounds for a jump by a human user.

4. The jump sensor device of claim 1 further including an audio output device electronically connected to the computing device and the computing device is further programmed to prompt the user to jump with a sound from the audio device.

5. The jump sensor of claim 2 wherein the acoustical source is placed on the ground in the vicinity of a user and the acoustical detector is attached to the user.

6. The jump sensor of claim 2 wherein the acoustical source is attached to the user and the acoustical detector is placed on the ground in the vicinity of the user.

7. The jump sensor of claim 1 further including a third sensor that can detect a distance said third sensor one of an acoustical source and acoustical detector, and, an optical source and optical detector, and said third sensor attached to a user's wrist and said second sensor attached to a user's leg.

8. A jump sensor device comprising:
a) a first sensor that can detect a movement said sensor one of an accelerometer, a switch and a strain gauge,
b) a plurality of second sensors that can detect a distance said plurality of second sensors one of acoustical sources and acoustical detectors, and, optical sources and optical detectors, said plurality of second sensors located around a user such that the user's location may be determined by distance measurements from said plurality of second sensors and a triangulation calculation,
c) a computing device that is programmed to: accept user preferences, acquire data from the sensors during a jump sequence by a user, to calculate measurements related to the jump, and, to report the measurements, where the measurements include at least one of: the height of the jump, the duration of the jump, the force expended, the energy expended during the jump, the average power for the jump, and the instantaneous power for the jump,
d) where the computing device is programmed to use the data from the sensors to determine the time at the start of the jump, the height of the jump, the time of the end of the jump, and the triangulation calculation of the location of the user during the jump.

9. The jump sensor device of claim 8 wherein the first sensor is an accelerometer and the plurality of second sensors are acoustical sources and acoustical sensors.

10. The jump sensor of claim 9 wherein each of the plurality acoustical sources of the plurality of second sensors operate at a different acoustical frequency thereby eliminating interference between measurements by each of the plurality of acoustical detectors.

11. The jump sensor device of claim 8 wherein the computing device is further programmed to mathematically fit the height data from the plurality of second sensors to a parabolic curve and based upon the fit determine if the data measured by the plurality of sensors is within pre-selected bounds for a jump by a human user.

12. The jump sensor device of claim 8 further including an audio output device electronically connected to the computing device and the computing device is further programmed to prompt the user to jump with a sound from the audio device.

13. The jump sensor of claim 8 wherein the plurality of acoustical sources are placed on the ground in the vicinity of a user and an acoustical detector is attached to the user.

14. The jump sensor of claim 8 wherein the plurality of acoustical sources are attached to the user and the plurality of acoustical detectors are placed on the ground in the vicinity of the user.

15. The jump sensor of claim 8 further including a third sensor that can detect a distance said third sensor one of an acoustical source and acoustical detector, and, an optical source and optical detector, and said third sensor attached to a user's wrist and said plurality of second sensors attached to a user's leg.
